(19) United States
(12) Patent Application Publication
(10) Pub. No.: US 2003/0225716 A1
(43) Pub. Date: Dec. 4, 2003

(54) Programmable or expandable neural network

(76) Inventors: Bingxue Shi, Beijing (CN); Guoxing Li, Beijing (CN)

Correspondence Address: Finnegan, Henderson, Farabow,, Garrett & Dunner, L.L.P., 1300 I Street, N.W., Washington, DC, 20005-3315, US

(21) Appl. No.: 10/158,067

(22) Filed: May 31, 2002

(51) Int. Cl. G06N 3/02; G06F 15/18; G06N 3/06; G06N 3/063; G06N 3/067

(52) U.S. Cl. 706/26; 706/31; 706/41

(57) ABSTRACT

A neural network includes a programmable template matching network and a winner take all network. The programmable template matching network can be programmed with different templates. The WTA network has an output which can be reconfigured and the scale of the WTA network can expanded.

### DESCRIPTION OF THE INVENTION

1. Field of the Invention

The present invention relates to Hamming neural networks.

2. Background of the Invention

A neural network is an interconnected assembly of simple processing elements, called nodes, whose functionality is loosely based on the human brain, in particular, the neuron. The processing ability of the network is stored in inter-node connection strengths, called weights, obtained by learning from a set of training patterns. The learning in the network is achieved by adjusting the weights based on a learning rule and training patterns to cause the overall network to output desired results.

The basic unit of a neural network is a node. FIG. 1 is an example of a neural network node 100. Neural network node 100 functions by receiving an input vector X composed of elements x₁, x₂, . . . xₙ. Input vector X is multiplied by a weight vector W composed of elements w₁, w₂, . . . wₙ. The resultant product is inputted into a linear threshold gate (LTG) 110. LTG 110 sums the product of X and W. The sum is then compared with a threshold value T. An output value y is output from LTG 110 after the sum is compared to threshold value T. If the sum is greater than threshold value T, a binary 1 is output as y. If the sum is less than the threshold value T, a binary 0 is output as y.

A conventional neural network comprises multiple nodes arranged in layers. FIG. 2 is a diagram of a conventional neural network 200. Conventional neural network 200 comprises two layers, a first layer 210 and a second layer 220. First layer 210 comprises a k number of nodes. Second layer 220 comprises a single node. The nodes in first layer 210 and second layer 220 may be, for example, an LTG, such as LTG 110 illustrated in FIG. 1. Conventional neural network 200 functions by receiving an input vector X comprising elements x₁, x₂, and xₙ at first layer 210. First layer 210 processes input vector X and outputs the results to second layer 220. The nodes of first layer 210 may process input vector X by the method described for the node shown in FIG. 1. The results outputted from first layer 210 are inputted into second layer 220. Second layer 220 processes the results and outputs a result y. The node of second layer 220 may process the result from first layer 210 using the method described for the node shown in FIG. 1.

Neural networks are effective in performing many applications because of their many advantages compared to conventional algorithmic methods. Such advantages include an increase in speed and a greater degree of robustness to component failure resulting from the neural networks parallel computation and distributed processing. In particular, a Hamming network is a type of neural network which has potential to be used for many computational applications. One advantage of the Hamming network is its simple structure. While it has a simple structure, the Hamming network can be used for applications, such as a minimum error classifier. As a classifier, the Hamming network can determine which of the M classes an unknown static input pattern containing N elements belongs to. Additionally, the Hamming network can be easily implemented with electronic technology.

FIG. 3 illustrates a Hamming neural network 300. Hamming neural network 300 comprises two sub-networks, a template matching network 310, and a winner take all (WTA) network 320. The first sub-network of the Hamming neural network is template matching network 310. Template matching network 310 comprises N nodes. Stored in each node is a different template. Template matching network 310 serves to match an input vector with one of the templates which is stored in each node of template matching network 310. Each template stored in the node is a different variation of the possible configuration of the input vector. Each node of template matching network 310 outputs a matching score which represents how similar the input vector is to the template stored in that node. Template matching network 310 ideally has sufficient nodes such that wide variations of the input vector are available and therefore the input vector can be closely correlated to a template stored in a node.

Template matching network 310 functions by receiving an input vector D{=D₁,D₂, . . . ,D_{N}>,Dᵢ∈[0,1]}. Each node of template matching network 310 receives input vector D and compares the input vector D with the template stored in each node. Matching scores Sⱼ(j=1,2, . . . ,M), wherein M is the number of nodes, will be generated for each node, which represent the correlation between an input vector D{=D₁,D₂, . . . ,D_{N}>,Dᵢ∈[0,1]} and templates stored in the node. The matching scores can be expressed in the following equation:

$$[ 008 ] {S}_{j} = {\sum }_{i = 1}^{N} \overline{{D}_{i} ⊕ {P}_{i}^{j}} / j = 1 , 2 , … , M \qquad ( 1 )$$

where Pᵢ^{j}[0,1] is the bit of the jth template, M is the number of nodes, and N is the number of bits in the input vector. The matching scores are then transferred to WTA network 320.

The second sub-network of Hamming neural network 300 is WTA network 320. WTA network 320 comprises M nodes. The output of a single node in template matching network 310 is connected to a single node in WTA network 320. The matching scores Sⱼ are transferred from each node of template matching network 310 to the corresponding node of WTA network 320. Then, WTA network 320 selects the node with the maximum matching score from the M inputs and forces the output of that node to ‘1’ and the rest of the nodes to ‘0’. The node with the maximum matching score is considered the “winner”. Once the “winner” is determined, an output Y{=Y₁,Y₂, . . . ,Yₘ}, where m is the number of nodes, is generated and output for the m node which received the maximum matching score. Therefore, the output Y of that node will be “1”. Thus, the node from template matching network 310, which is coupled to the “winner” node of WTA network 320, is the node storing the template which matches input vector D.

An example of a Hamming neural network would be a pattern matching network. This neural network would function to match an input pattern with stored templates which represent variations of the input pattern. The input vector, for example, may be an input vector representing a picture where each bit of the vector represents a visual feature in the picture. In each node of the template matching network of the Hamming neural network would be stored templates which have different variations of features of the picture. The Hamming neural network would have the ability to match the input vector with the template most closely matching the input vector.

The performance and structural simplicity of a Hamming network makes the network an attractive candidate for Very Large Scale Integration (VLSI) realization. Presently, Hamming networks have been implemented in current based, charge based, and voltage based circuitry. However, all these implementations of Hamming networks have a problem such that the templates stored in the template matching network are fixed. In other words, when the network is manufactured in hardware form, the templates are “hard coded” in the network. Changes in the templates would not be able to be made unless the hardware was changed. Further, conventional Hamming networks have an additional disadvantage such that the output from the WTA network is in a fixed form. In other words, when the network is manufactured in hardware form, the WTA network would only be designed to output results in one form, such as current. These disadvantages reduce the flexibility of conventional Hamming networks in many application areas. Certain aspects related to the present invention improve on conventional Hamming networks by creating a circuit for performing template matching which can be programmed. Also, certain aspects related to the present invention are directed to a circuit for performing the function of a WTA network for which the output can be reconfigurable and the scale of the WTA network can be expandable.

### SUMMARY OF THE INVENTION

Accordingly, one aspect related to the present invention is directed to a circuit for performing template matching which can be programmed. Also, another aspect related to the present invention is directed to a circuit for performing the functions of a WTA network for which the output can be reconfigurable and the scale of the WTA network can be expandable.

One aspect related to the present invention is directed to a neural network comprising: a programmable template matching (PTM) network for receiving an input vector, comparing the input vector to a template, and generating a matching signal current; and a winner take all (WTA) network coupled to the output of the current mode programmable template matching network for sorting the matching signal currents generated by the current mode programmable template matching network.

Additional features and advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the present invention and together with the description, serve to explain the principles of the invention.

FIG. 1 is a diagram of a node of a conventional neural network;

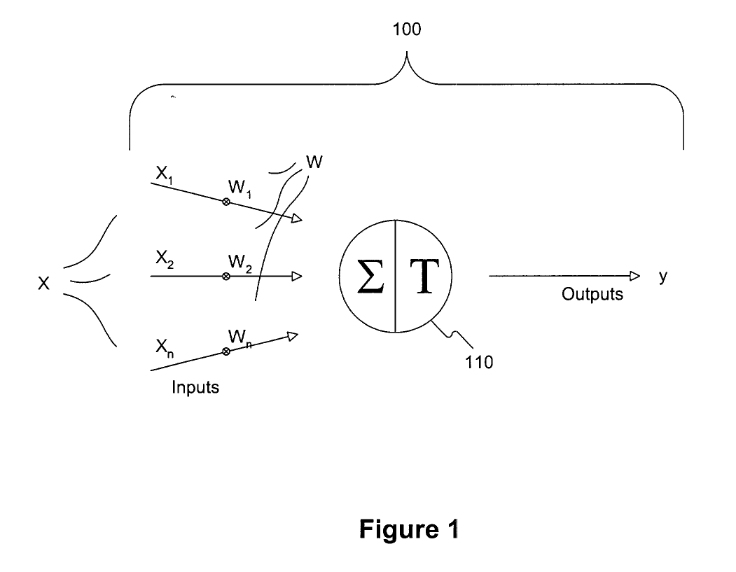

FIG. 2 is a diagram of a conventional multilayer neural network;

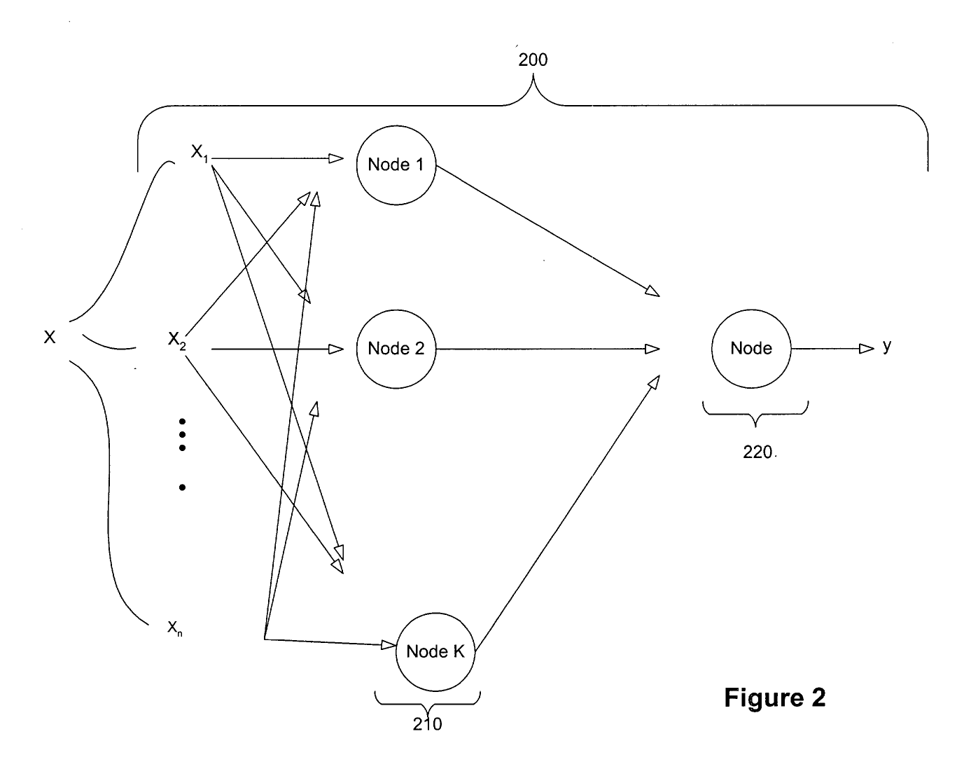

FIG. 3 is a diagram of a conventional Hamming neural network;

FIG. 4 is a diagram of a programmable template matching circuit according to certain aspects related to the present invention;

FIG. 5 is a graph of matching current I_{MS} in relation to matching degree according to certain aspects related to the present invention;

FIG. 6 is a diagram of a winner take all (WTA) network;

FIG. 7 is a diagram of timing of clocks and control signals according to certain aspects related to the present invention;

FIGS. 8A-D are diagrams of measured and simulated waveforms of three outputs according to certain aspects related to the present invention.

### DESCRIPTION OF THE EMBODIMENTS

Reference will now be made in detail to the embodiments of the present invention, examples of which are illustrated in the accompanying drawings. Wherever possible, the same reference numbers will be used throughout the drawings to refer to the same or like parts.

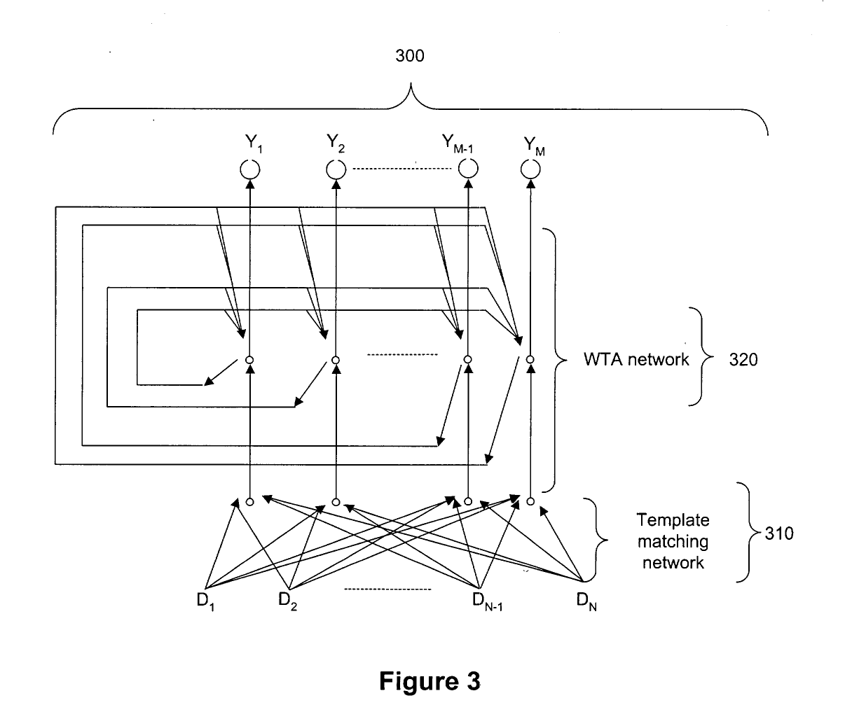

The present invention is directed to a current-mode programmable and expandable Hamming neural network. One aspect related to the present invention is a programmable template matching (PTM) circuit which functions as a template matching network, such as template matching network 310 as shown in FIG. 3. Another aspect related to the present invention is an expandable WTA network circuit. The WTA network circuit functions as a WTA network, such as WTA network 320 as shown in FIG. 3. The WTA network circuit can output a desired number of maximum matching currents from M number of nodes in a particular sorting order. For example, a WTA network circuit may output the first three maximum matching current in the sorting order of highest to lowest matching current.

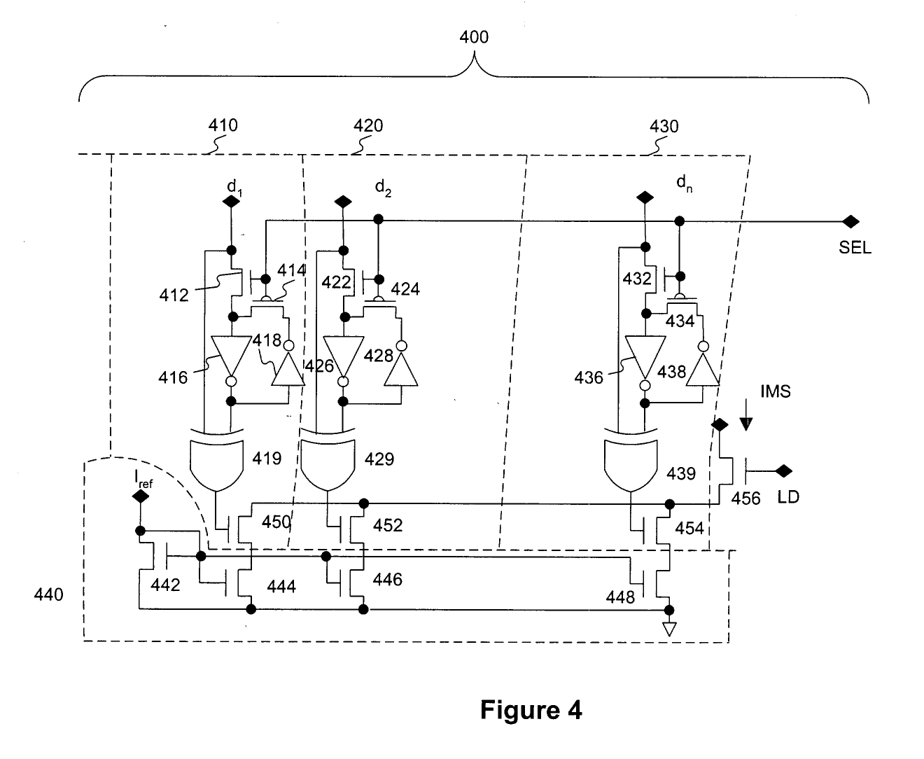

A first aspect related to the present invention is a programmable template matching circuit (PTM) 400 as shown in FIG. 4. PTM circuit 400 would function as a node in a template matching network, such as template matching network 310 shown in FIG. 3. FIG. 4 illustrates one PTM circuit for storing only one template, where dᵢ (for i=1 to N, where N is the number of bits in the vector), is one bit of input vector. One skilled in the art would realize the template matching network would comprise multiple PTM circuits (not shown) with each circuit storing a particular template. PTM circuit 400 functions in two modes, a programming mode and a template matching mode. The state of decoding signal SEL determines which mode PTM circuit 400 is in. Signal SEL has two states, logical high and logical low. For example, signal SEL may be a achived by applying 5V for logical high and 0V for logical low. When decoding signal SEL is high, the template is programmed by the input vector D=<d₁,d₂, . . . ,d_{N}>. When decoding singal SEL is low, the input vector D=<d₁,d₂, . . . ,d_{N}> will be matched with the pattern stored in the template and a matching current IMS is generated if the LD signal is high. LD is a clock signal which determines the timing of the output of PTM circuit 400. The additional PTM circuits (not shown) would function the same as PTM circuit 400.

PTM circuit 400 comprises a template storage and matching (TSM) sections 410, 420, and 430, a current mirror 440, and transistor 456. TSM sections 410, 420, and 430 are composed of a series of transistors, inverters, and gates. TSM sections 410, 420, and 430 each store a single bit of the matching template. TSM section 410 is composed of transistors 412, 414, and 450, inverters 416 and 418, and XOR gate 419. Likewise, TSM sections 420 and 430 are composed of transistors 422, 424, 432, 434, 452, and 454, inverters 426, 428, 436, and 438, and XOR gates 429 and 439. One skilled in the art would realize PTM circuit 400 is not limited to three TSM sections. PTM circuit 400 may have additional TSM sections for storing additional bits of a template. The transistors in each of the different sections may be for example, field effect transistors (FET), such as an n-type channel metal oxide semiconductor (NMOS), or a p-type channel metal oxide semiconductor (PMOS).

The first section of PTM circuit 400 is TSM section 410. In TSM section 410, an input for receiving a template bit d₁ is coupled to the source of NMOS transistor 412 and a first input of XOR gate 419. The programming area of TSM section 410 is composed of NMOS transistor 412 and PMOS transistor 414 which are coupled to an input of inverter 416. The gates of NMOS transistors 412 and PMOS transistor 414 are supplied with a signal SEL. An output of inverter 418 is coupled to the drain of PMOS transistor 414. An output of inverter 416 is coupled to a second input of XOR gate 419 and an input of inverter 418. An output of XOR gate 419 is coupled to the gate of NMOS transistor 450. TSM sections 420 and 430 are configured the same as TSM section 410.

Another section of PTM circuit 400 comprises current mirror 440. Current mirror 440 is composed of transistors 442, 444, 446, and 448, which for example, may be NMOSFETs. In FIG. 4, I_{ref} represents an externally applied reference current. In current mirror 440, I_{ref} is coupled to the source and gate of NMOS transistor 442. Additionally, the gates of NMOS transistors 444, 446, and 448 are coupled to the gate of NMOS transistor 442. Sources of NMOS transistors 444, 446, and 448 and the drain of NMOS transistor 442 are coupled to ground. Current mirror 440 is configured as a series of current sources to produce a current at each of the drains of NMOS transistors 444, 446, and 448 that is approximately equal to I_{ref}. This approximately equal current is supplied to TSM sections 410, 420, and 430 through NMOS transistors 450, 452, and 454, respectively. To supply the current, the drains of NMOS transistors 444, 446, and 448 are coupled to the sources of NMOS transistors 450, 452, and 452, respectively.

PTM circuit 400 functions in two modes, a programming mode and a template matching mode. The mode of PTM circuit 410 is determined by signal SEL. When the signal SEL is high, NMOS transistor 412 conducts and input vector bit d₁ is transferred to inverters 416 and 418, the drain of PMOS transistor 414, and an input of XOR gate 419 in order to program a bit of the template. The same operation occurs simultaneously in TSM sections 420 and 440 for the other bits d₂ and d_{N}.

Next, the signal SEL becomes low and PTM circuit 400 is in template matching mode. When the signal SEL is low, PMOS transistor 414 conducts and stored input vector bit d₁ is transferred to the second input of XOR gate 419. Simultaneously, input vector bit d₁ is transferred to the first input of XOR gate 419. If the bits do not match, then the output of XOR gate 419 is logical high and NMOS transistor 450 conducts. Conversely, if the bits do match, the output of XOR gate 419 is low and NMOS transistor 450 does not conduct. The XOR gate properly determines if the input bit and the stored bit match because the stored bit is inverted due to being operated on by three inverter operations (twice by inverter 416 and once by inverter 418). The same process occurs simultaneously for the comparison of bits d₂ and d_{N} in TSM sections 420 and 430.

A matching current I_{MS} is generated from the current supplied from current mirror 440 to NMOS transistors 450, 452, and 454. I_{MS} is generated when an input bit does not match the inverted stored bit causing XOR gate 419 to output logical high signal. Thus, NMOS transistor 450 conducts and the current from NMOS transistor 444 contributes to I_{MS}. As described above, current mirror 440 produces a current approximately equal to I_{ref} at the drains of NMOS transistors 444, 446, and 448. Therefore, the more input bits that don't match the inverted stored bits, the larger I_{MS} will be. I_{MS} of PTM circuit 400 is expressed by the following equation:

$$[ 035 ] {I}_{MS} = {I}_{ref} [ {\sum }_{i = 1}^{N} {d}_{i} ⊕ {\overline{P}}_{i} ] \qquad ( 2 )$$

where Pᵢ∈[0,1]} is the bit of the template. In other words, IMS is approximately equal to I_{ref} times the number of matching bits. Therefore, the more bits that match, the larger I_{MS} will be. The output of IMS is determined by the timing of signal LD. I_{MS} is output from PTM circuit 400 when signal LD, supplied to the gate of NMOS transistor 456, becomes high.

As described above, the degree input vector D matching the programmed template is determined from the value of I_{MS}. I_{MS} is generated from the current supplied from NMOS transistors 450, 452, and 454. These transistors only supply a current when a bit of input vector D matches the programmed template. Thus, the larger the value of I_{MS}, the greater the degree of matching between input vector D and the programmed template.

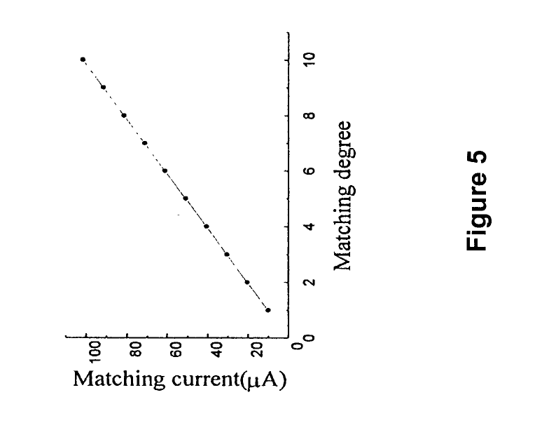

The relation between matching current and matching degree is depicted in FIG. 5, where I_{ref}=10 μA and the PTM circuit contains 10 TSM circuits for storing a 10 bit template. As it can been see from FIG. 5, the greater the degree of matching present, the larger IMS is. Therefore, in a template matching network employing multiple TSM circuits, the circuit with the largest I_{MS} would contain the template which most closely matches input vector D. Once I_{MS} signal is determined and clock signal LD goes, the I_{MS} is transferred to a WTA network.

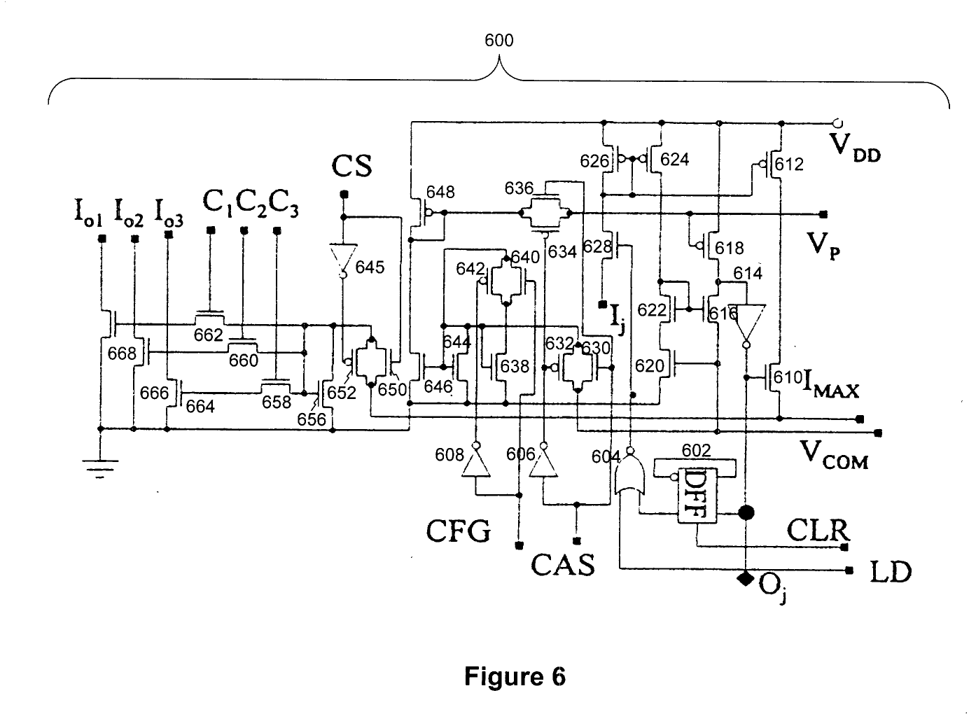

Another aspect related to the present invention is an expandable WTA network circuit. The WTA network circuit functions as a node of a WTA network, such as WTA network 320, as shown in FIG. 3. The WTA network circuit can output a desired number of maximum matching currents from M nodes in a sorting order. FIG. 6 illustrates a WTA network circuit 600 for sorting I_{MS} signals received from a template matching network, for example, TSM circuits illustrated in FIG. 4. WTA network circuit 600 is the jth cell of a WTA network which is comprised of M units. One skilled in the art would relize the WTA network contains additional WTA network circuits, specifically a WTA network circuit corresponding to each PTM network node. WTA network circuit 600 comprises a combination of transistor and digital logic circuits which allow the circuit to sort the matching currents and control the output of the circuit. WTA network circuit 600 is controlled by control signals CFG, CAS, and CS. Control signals CFG, CAS, and CS determine the output format of the WTA network. Control signals CFG, CAS, and CS have two states, logical high and logical low. The state of the control signals controls the state of transmission gates. Transmission gates are logic circuitry formed by an NMOS transistor and a PMOS transistor in which the drain of one is connected to the source of the other. A transmission gate allows current to flow if the voltage supplied to the gate of the NMOS transistor is high and the voltage supplied to the gate of the PMOS transistor is low. In WTA circuit 600, the control signals are directly connected to the gate of an NMOS transistor and connected to the gate of an PMOS transistor through an inverter. Therefore, the above formed gate allows “transmission” of current when the control signal is logical high.

As shown in FIG. 6, signal CS is coupled to the gate of an NMOS transistor 650. Signal CS is also coupled to the gate of PMOS transistor 652 through an inverter 645. When signal CS is high, current is allowed to flow through the transmission gate formed by transistors 650 and 652. Likewise, signal CFG is coupled to the gate of an NMOS transistor 640 and the gate of a PMOS transistor 642 through an inverter 608. When signal CFG is high, current is allowed to flow through the transmission gate formed by transistors 640 and 642. Signal CFG is coupled to the gate of an NMOS transistor 636 and the gate of a PMOS transistor 634 through an inverter 606. Also, signal CFG is coupled to the gate of an NMOS transistor 630 and the gate of a PMOS transistor 632 through an inverter 606. When signal CFG is high, current is allowed to flow through the transmission gates formed by transistors 636 and 634 and by transistors 630 and 632.

WTA network circuit 600 also receives inputs V_{DD}, V_{P}, V_{COM} and I_{MAX}. V_{P}, V_{COM} and I_{MAX} are signals for expansion, which other cells in the WTA network also receive. An expended neural network may be constructed by connecting two circuits of neural network through these three signals peer to peer. V_{DD} is the drain supply voltage for WTA network circuit 600.

V_{P} is coupled to the gate and drain of PMOS transistor 648 through the transmission gate formed by NMOS transistor 636 and PMOS transistor 634. VCOM is coupled to the gate of NMOS transistor 638, the gate of NMOS transistor 646, and the gate and drain of NMOS transistor 644 through the transmission gate formed by NMOS transistor 630 and PMOS transistor 632. I_{MAX} is coupled to the drain of NMOS transistor 662, the drain of NMOS transistor 660, and the drain of NMOS transistor 656 through the transmission gate formed by NMOS transistor 650 and PMOS transistor 652. V_{DD} is coupled to the source of PMOS transistor 648.

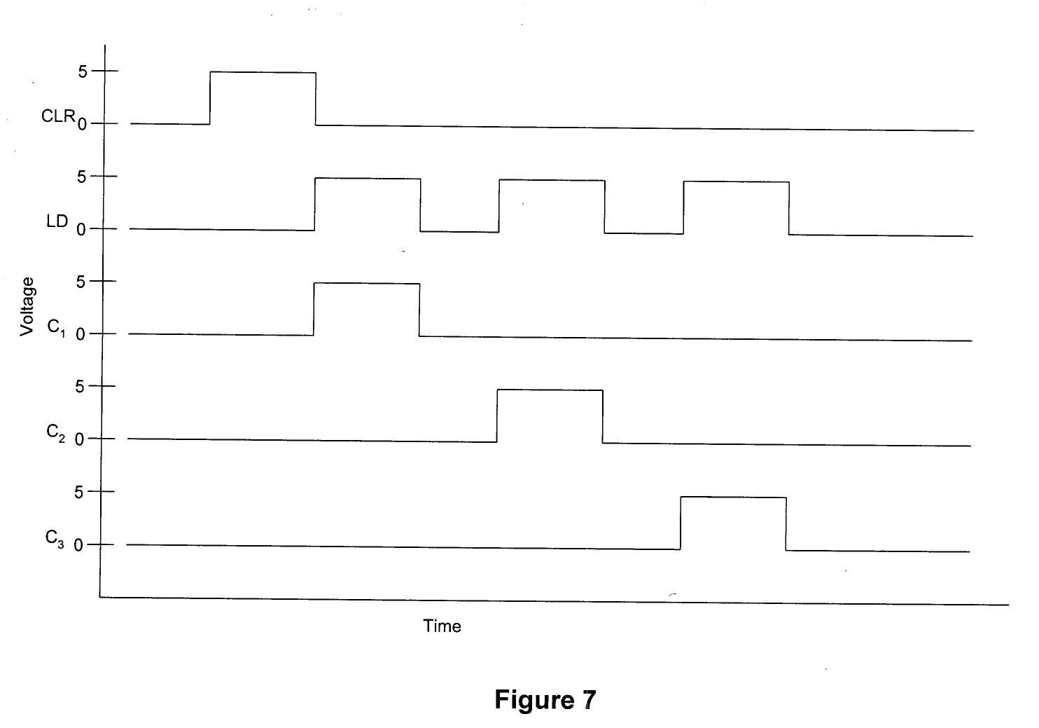

Iₒ₁, Iₒ₂, and Iₒ₃ are output currents with the first three maximum matching scores in decreasing order. C₁, C₂, and C₃ are three phase clocks to trace the maximum matching current and the timing of these three clocks is shown in FIG. 7. Clock signal LD and reset signal CLR which control the timing of WTA network circuit 600 are shown in FIG. 7. Iₒ₁ is coupled to the source of NMOS transistor 668. The gate of NMOS transistor 668 is coupled to the source of NMOS transistor 662. The gate of NMOS transistor 662 is coupled to C₁. Likewise, Iₒ₂ is coupled to the source of NMOS transistor 666. The gate of NMOS transistor 666 is coupled to the source of NMOS transistor 660. The gate of NMOS transistor 660 is coupled to C₂. Also, Iₒ₃ is coupled to the source of NMOS transistor 664. The gate of NMOS transistor 658 is coupled to the source of NMOS transistor 658. The gate of NMOS transistor 658 is coupled to C₃. The drains of NMOS transistors 668, 666, and 664 are coupled to ground. Further, the drains of NMOS transistors 662, 660, 658 are coupled to the gate and drain of NMOS transistor 656.

DFF 602 is a D type flip-flop. DFF 602 is controlled by rest signal CLR. Iⱼ is the input current from the jth template of the PTM network into the jth cell of WTA sorting network. Iⱼ is coupled to a series of NMOS and PMOS transistors in order to convert the current to a voltage, sort the currents, and store the voltages. Iⱼ is coupled to the drain of NMOS transistor 428. The source of transistor 628 is coupled to the drain and gate of PMOS transistor 626, the source and gate of PMOS transistor 624, and the gate of PMOS transistor 612. The drains of PMOS transistors 624, 612 and the source of PMOS transistor 626 are coupled to VDD.

The source of transistor 624 is coupled to the source and gate of NMOS transistor 622 and coupled to the gate of NMOS transistor 616. The drain of NMOS transistor 616 is coupled to the source of PMOS transistor 618 and an input of inverter 614. The drain of PMOS transistor 618 is coupled to V_{DD} and the gate of PMOS transistor 618 is coupled to Vp. The source of NMOS transistor 616 is coupled to the gate of NMOS transistor 620 and signal V_{COM}.

The output of inverter 614 is coupled to the gate of NMOS transistor 610, the input of DFF 602, and Oⱼ. Oⱼ is the output voltage of the jth cell. The output of DFF 602 is coupled to an input of XOR gate 604. Signal LD is coupled to another input of XOR gate 604. An output of XOR gate 604 is coupled to the gate of transistor 628. The drain of NMOS transistor 610 is coupled to the source of PMOS transistor 612 and the source of NMOS transistor 610 is coupled to I_{MAX}. The drain of NMOS transistor 646, the sources of NMOS transistors 644, 638, and the drain of NMOS transistor 620 are connected to ground.

The WTA network circuit 600 described above has a high resolution in that the circuit may sense the minimum difference among all the matching currents. When WTA network circuit 600 functions to output the maximum matching currents, CAS and CS are high and CFG is low. As shown in FIG. 7, the circuit starts with CLR going to logical high. DFF 602 is reset when CLR goes to logical high. Next, LD goes to logical high. In this state, LD is high which is connected to an input of XOR gate 604 and the output of DFF 602 is at logical low which is connected to the other input of XOR gate 604. Thus, XOR gate 604 outputs a logical high signal and therefore NMOS transistor 625 conducts. When this occurs, Iⱼ is read in, compared to the current of other WTA circuits, and the matching current is converted to a voltage. If the jth matching current is the maximum, then Oⱼ will go high level. The output Oⱼ is registered in the DFF and the output of DFF 602 will close the maximum matching current after the first LD. Next, C₁ goes to logical high at this time and I₁ will trace the maximum matching current based on the switched-current trace/hold (SI-T/H) technique. The output terminals corresponding to the second and the third matching currents will go high level in turn and the 12 and 13 will trace as C₁ and C₂ and go to logical high, respectively, and hold these two currents based on the switched-current trace/hold (SI-T/H) technique.

WTA network circuit 600 can function in single chip or multiple chip modes. If WTA network circuit 600 functions in single chip, it can be reconfigured to select the maximum matching current only or select the first three maximum matching currents and also make their corresponding voltage output to high level in time sharing mode according to different configuration of CFG, CAS and CS. WTA network circuit 600 may be easily expanded by connecting the terminals of Vp, IMAX and VCOM with the same name, then, it can even select the first six maximum matching currents and also their voltage outputs in sorting order under the proper control of CAS and CS.

In the case where the WTA network is expanded, CS and CAS are used to configure the expansion mode. Different values of CS and CAS will configure different modes of expansion. The CFG is used to configure WTA network 600. For example, CFG is kept low in time sharing or multi-chip mode. In time sharing mode when CFG is kept high, WTA network 600 will select the two most optimized compatibility output.

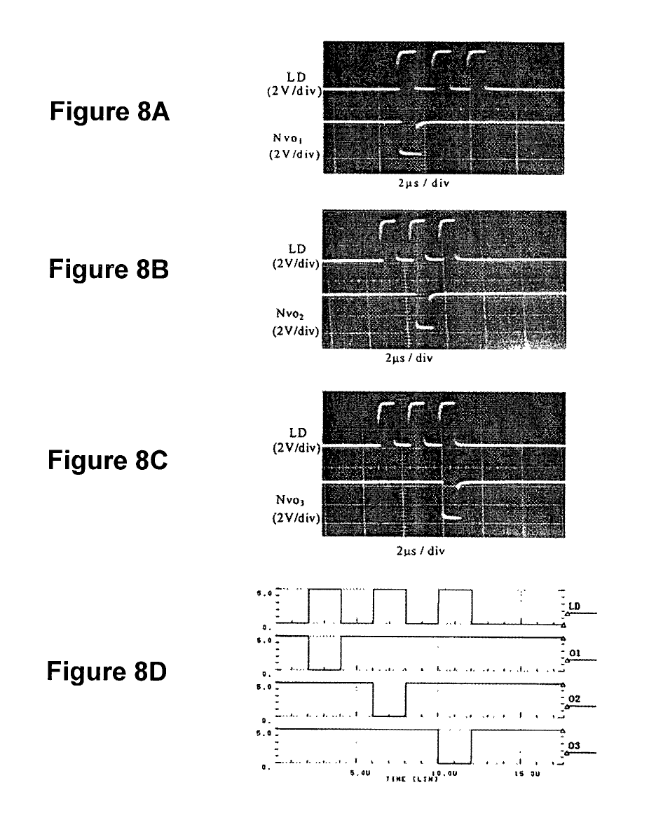

An example of results achieved with the present invention will now be described for a Hamming neural network comprising a template matching network having ten PTM circuits, as shown in FIG. 4 and a WTA network comprising ten WTA circuits, as shown in FIG. 6. The external applied reference current I_{ref} is chosen to be 10 μA in this example. In this example, the template programming is first programmed and then it functions like a Hamming neural chip with fixed templates. The ten PTM circuits have ten different templates from each other and the templates may be transferred via a parallel port from a computer. The input vector, completely matching one of ten templates, is set before the template programming. FIGS. 8A-D illustrate oscilloscope displays of measured waveforms and HSPICE simulation waveforms of three voltages output. In this example, an inverse buffer is coupled to the output. Thus, a logical low level, or −5V represents a valid output. FIGS. A, B, and C are, respectively, the output waveforms from the first circuit with the maximum matching current to the third circuit with the third maximum matching current. FIG. 8D shows the results of HSPICE simulation. It can be seen from these figures that the simulation results illustrated in FIG. 8D match the experimental results illustrated in FIGS. 8A-C. As shown in the Figures, in the first LD, the O1 goes to high level since the input vector matches the first template completely. In the last two LD clocks, O2 and O3 rise to V_{DD} in sequence.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A neural network comprising:
a programmable template matching (PTM) network for receiving an input vector, comparing the input vector to a template, and generating a matching signal current; and
a winner take all (WTA) network coupled to the output of the current mode programmable template matching network for sorting the matching signal currents generated by the current mode programmable template matching network.

2. The neural network as set forth in claim 1, wherein the PTM network comprises a plurality of template matching circuits, each template matching circuit comprises:
an input for receiving the input vector;
a plurality of template storing and matching (TSM) sections coupled to the input for storing the template and matching the template with the input vector;
a current mirror coupled to the TSM section for supplying the TSM section with a reference current; and
an output.

3. The neural network as set forth in claim 2, wherein each TSM section comprises:
a bit input;
a first transistor coupled to a selection signal source;
a second transistor coupled to the first transistor and the selection signal source;
a first inverter coupled to the first and second transistor;
a second inverter coupled to the first inverter and the second transistors;
an exclusive-or (XOR) gate coupled to the bit input and the second inverter; and
a third transistor coupled to the XOR gate and the current mirror for generating the matching signal current.

4. The neural network as set forth in claim 3, wherein the current mirror comprises:
a fourth transistor coupled to a reference current source; and
a plurality of other transistors coupled to the fourth transistor and the reference current source.

5. The neural network as set forth in claim 1, wherein the WTA network comprises:
an input for receiving the matching signal current;
a converting means coupled to the input for converting the matching signal currents to a matching signal voltage;
a sorting means coupled to the input and converting means for determining a first maximum current, a second maximum current, and a third maximum current;
a storing means for storing the matching signal voltage;
a first output coupled to the storing means for outputting the matching signal voltage;
a second output coupled to the sorting means for outputting the first maximum current;
a third output coupled to the sorting means for outputting the second maximum current; and
a fourth output coupled to the sorting means for outputting the third maximum current.

6. The neural network as set forth in claim 5, wherein the second, third, and fourth outputs output the first, second, and third maximum currents in response to a first, a second, and a third signal, respectively.

7. The neural network as set forth in claim 5, wherein the converting means, the sorting means, and the storing means are controlled by a first, a second, and a third control signal.

8. A neural network comprising:
a programmable template matching (PTM) network for receiving an input vector, comparing the input vector to a template, and generating a matching signal current.

9. The PTM network as set forth in claim 8, further comprising a plurality of template matching circuits, each template matching circuit comprises:
an input for receiving the input vector;
a plurality of template storing and matching (TSM) sections coupled to the input for storing the template and matching the template with the input vector;
a current mirror coupled to the TSM section for supplying the TSM section with a reference current; and
an output.

10. The neural network as set forth in claim 9, wherein each TSM section comprises:
a bit input;
a first transistor coupled to a selection signal source;
a second transistor coupled to the first transistor and the selection signal source;
a first inverter coupled to the first and second transistors;
a second inverter coupled to the first inverter and the second transistor;
an exclusive-or (XOR) gate coupled to the bit input and the second inverter; and
a third transistor coupled to the XOR gate and the current mirror for generating the matching signal current.

11. The neural network as set forth in claim 10, wherein the current mirror comprises:
a fourth transistor coupled to a reference current source; and
a plurality of other transistors coupled to the fourth transistor and the reference current source.

12. A neural network comprising:
a winner take all (WTA) network for sorting signal currents.

13. The neural network as set forth in claim 12, wherein the WTA network comprises:
an input for receiving the signal currents;
a converting means coupled to the input for converting the signal currents to a signal voltage;
a sorting means coupled to the input and converting means for determining a first maximum current, a second maximum current, and a third maximum current;
a storing means for storing the matching signal voltage;
a first output coupled to the storing means for outputting the signal voltage;
a second output coupled to the sorting means for outputting the first maximum current;
a third output coupled to the sorting means for outputting the second maximum current; and
a fourth output coupled to the sorting means for outputting the third maximum current.

14. The neural network as set forth in claim 12, wherein the second, third, and fourth outputs output the first, second, and third maximum currents in response to a first, a second, and a third signal, respectively.

15. The neural network as set forth in claim 12, wherein the converting means, the sorting means, and the storing means are controlled by a first, a second, and a third control signal.
